(19) United States
(12) Patent Application Publication
(10) Pub. No.: US 2020/0027369 A1
(43) Pub. Date: Jan. 23, 2020

(54) CREATIVITY ASSESSMENT APPARATUS AND NON-TRANSITORY COMPUTER READABLE MEDIUM

(71) Applicant: FUJI XEROX CO., LTD., Tokyo (JP)

(72) Inventor: Ryoji HORITA, Kanagawa (JP)

(73) Assignee: FUJI XEROX CO., LTD., Tokyo (JP)

(21) Appl. No.: 16/371,133

(22) Filed: Apr. 1, 2019

(30) Foreign Application Priority Data
Jul. 23, 2018 (JP) 2018-137791

(51) Int. Cl. G09B 19/00

(52) U.S. Cl. CPC G09B 19/00

(57) ABSTRACT

A creativity assessment apparatus includes an acquisition unit that acquires bio-data indicating a measurement result of a biological state of a user, a computing unit that computes a degree of change in a balance between sympathetic nerve activity and parasympathetic nerve activity in accordance with the bio-data acquired by the acquisition unit, and an assessment unit that assesses creativity of the user in accordance with the degree of change computed by the computing unit.

### CROSS-REFERENCE TO RELATED APPLICATIONS

This application is based on and claims priority under 35 USC 119 from Japanese Patent Application No. 2018-137791 filed Jul. 23, 2018.

### BACKGROUND

### (i) Technical Field

The present disclosure relates to a creativity assessment apparatus and a non-transitory computer readable medium.

### (ii) Related Art

As competition becomes fierce in the market, many companies are trying to recruit creative staff or set an environment that enables staff to be creative in order to develop products or services with added value in a shorter period of time. A tool used to quantitatively assess an ability to create a fresh and creative idea may be an online test, such as that disclosed in Japanese Patent No. 6249466.

If the creativity test disclosed in Japanese Patent No. 6249466 is used to assess user creativity during a task or prior to the task, the creativity test is to be repeated several times and is thus time-consuming for the user.

### SUMMARY

Aspects of non-limiting embodiments of the present disclosure relate to a creative assessment apparatus that recognizes a user's creativity more easily than when a creativity test is performed multiple times in connection with a single task.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a creativity assessment apparatus. The creativity assessment apparatus includes an acquisition unit that acquires bio-data indicating a measurement result of a biological state of a user, a computing unit that computes a degree of change in a balance between sympathetic nerve activity and parasympathetic nerve activity in accordance with the bio-data acquired by the acquisition unit, and an assessment unit that assesses creativity of the user in accordance with the degree of change computed by the computing unit.

### BRIEF DESCRIPTION OF THE DRAWINGS

Exemplary embodiments of the present disclosure will be described in detail in accordance with the following figures, wherein:

FIG. 1 generally illustrates a creativity assessment apparatus of a first exemplary embodiment of the disclosure;

FIG. 2 is a flowchart illustrating an operation of the creativity assessment apparatus of FIG. 1;

FIG. 3A illustrates an example of time characteristics of a cardiac beat-to-beat interval, and FIG. 3B illustrates frequency characteristics of the cardiac beat-to-beat interval of FIG. 3A;

FIG. 4 illustrates a computing method of the number of changes;

FIG. 5A illustrates an example of a change of activity in time, and FIG. 5B illustrates the number of changes in time;

FIG. 6A illustrates a statistical distribution of the number of changes with the same user being a population, and FIG. 6B illustrates an example of a conversion curve that converts the number of changes into a degree of demonstration;

FIG. 7 illustrates a first image of a display example of assessment information;

FIGS. 8A and 8B illustrate examples of detailed analysis results in a specific time band;

FIG. 9 generally illustrates a creativity assessment system including a creativity assessment apparatus of a second exemplary embodiment of the disclosure;

FIG. 10A illustrates a statistical distribution of the number of changes with multiple users being a population, and FIG. 10B illustrates an example of a conversion curve that converts the number of changes into a score; and

FIG. 11 illustrates a second image of a display example of the assessment information.

### DETAILED DESCRIPTION

### First Exemplary Embodiment

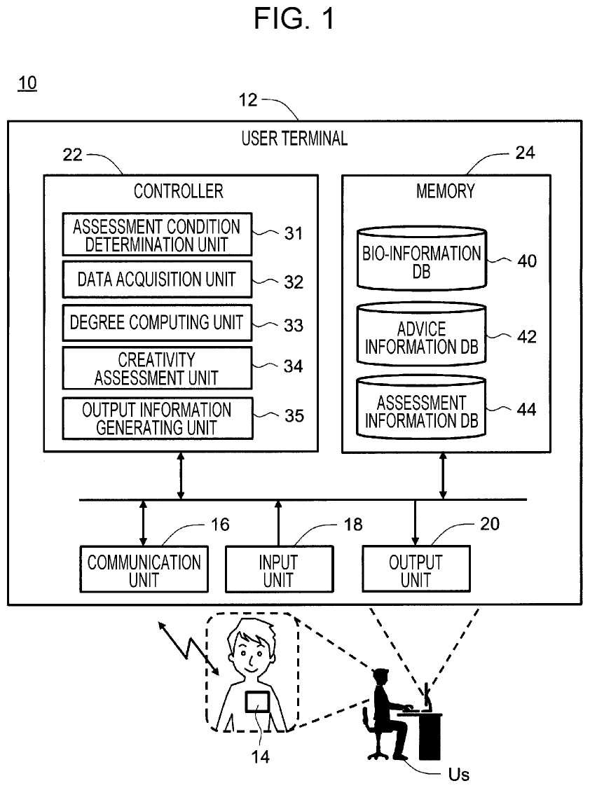

A first exemplary embodiment of the disclosure is described in connection with FIG. 1 through FIG. 8B.

FIG. 1 illustrates a creativity assessment apparatus 10 of a first exemplary embodiment of the disclosure. The creativity assessment apparatus 10 assesses creativity of a user Us as a subject (in particular, a demonstration state of creativity). The creativity assessment apparatus 10 includes a user terminal 12 and a bio-sensor 14.

The individual user Us wearing the bio-sensor 14 may now perform a task by using the user terminal 12. The bio-sensor 14 may measure the biological state, heart rate variability, pulse rate, and respiratory rate of the user Us. In addition to the bio-sensor 14, the user Us may wear a variety of sensors including a camera, a motion sensor, a position sensor, and a voice sensor. In such a case, the sensors may measure not only the heart rate, the pulse rate, and the respiratory rate, but also blood pressure, body temperature, pupil, gaze, motion, position, and voice of the user Us.

The user terminal 12 has multiple functions and multiple purposes that the user Us uses to perform a task. The user terminal 12 may be a personal computer, a tablet, or a smart phone. Specifically, the user terminal 12 includes a communication unit 16, an input unit 18, an output unit 20, a controller 22, and a memory 24.

The communication unit 16 is an interface that transmits or receives an electrical signal to or from an external device. The user terminal 12 is thus able to receive bio-data from the bio-sensor 14 and is able to transmit accordingly generated output information to the external device.

The input unit 18 may include an input device including a mouse, a keyboard, a touch sensor, and/or a microphone. The output unit 20 includes an output device including a display and a speaker. A combination of an input function of the input unit 18 and an output function of the output unit 20 forms a graphical user interface (GUI).

The controller 22 includes a processor, such as a central processing unit (CPU) or a micro-processing unit (MPU). By reading and executing a program stored in the memory 24, the controller 22 implements functions of an assessment condition determination unit 31, a data acquisition unit 32 (acquisition unit), a degree computing unit 33 (computing unit), a creativity assessment unit 34 (assessment unit), and an output information generating unit 35.

The memory 24 is non-transitory and includes a computer readable storage medium. The computer readable storage media include a removable medium, such as a magneto-optical disk, a read-only memory (ROM), a compact disk read-only memory (CD-ROM), or a flash memory, and a storage device, such as a hard disk, installed in a computer. The memory 24 stores data and the program in accordance with which the controller 22 controls each element of the creativity assessment apparatus 10.

The memory 24 includes a database for bio-information (hereinafter referred to as a bio-information database (DB) 40), a database for advice information (hereinafter referred to as an advice information DB 42), and a database for assessment information on creativity (hereinafter referred to as an assessment information DB 44).

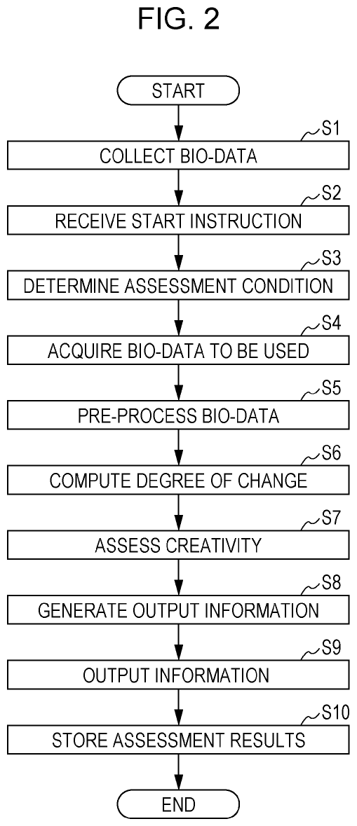

The creativity assessment apparatus 10 of the first exemplary embodiment is configured as described above. The operation of the creativity assessment apparatus 10 is described in connection with a flowchart of FIG. 2. In advance of the operation, the user Us as a subject wears the bio-sensor 14 on a specific location of the body (for example, on the location of the body surface corresponding to the heart) and starts a task in which creativity is demonstrated (for example, the user Us creates a document or organizes ideas).

In step S1 of FIG. 2, the user terminal 12 collects bio-data successively output from the bio-sensor 14. Before the user terminal 12 collects the bio-data, the bio-sensor 14 successively measures the biological state of the user Us and periodically or non-periodically outputs the obtained bio-data via communications. The communication unit 16 successively receives the bio-data from the bio-sensor 14. The controller 22 stores in the memory 24 the received data in association with related information. The bio-information DB 40 is thus stored and updated. An example of the related information is measurement time (year, month, day, hour, minute, and second), an amount of measurement (type and unit), identification (ID) information on the user Us, and type of task.

In step S2, the user terminal 12 receives an instruction to start an assessment process of creativity (hereinafter referred to as a start instruction). Specifically, before performing an operation intended to start the assessment process, the user Us inputs an assessment condition, to be described below, into the user terminal 12 via the input unit 18. The controller 22 thus receives the start instruction triggered by the operation of the user Us.

The start point of the assessment process may be prior to, in the middle of, or subsequent to the execution of the task. If the start point is subsequent to the execution of the task, the purpose of the assessment process is “post-analysis”, and if the start point is prior to the execution of the assessment process, the purpose of the assessment process is “pre-analysis”. If the start time is subsequent to the end of a preliminary task but prior to the start of a real task, the purpose of the assessment process is “preliminary analysis”.

In step S3, the assessment condition determination unit 31 determines one or more conditions (hereinafter referred to as assessment conditions) to identify an assessment target of creativity. Specifically, the assessment condition determination unit 31 determines the assessment condition by acquiring the information input in step S2. The assessment condition includes not only the user Us serving as an assessment target, and a time range, but also factors affecting the demonstration state of creativity (such as a time attribute, a location, and an environment). Examples of the “time attribute” include the morning, afternoon, off-duty hours, weekday, and weekend. Examples of the “location” include a conference room, a living room, and workplace inside or outside a company. Examples of the “environment” include weather, temperature, humidity, and a smaller or larger number of people coming and going.

In step S4, the data acquisition unit 32 acquires the bio-data that is used in the assessment process to be performed later. From the bio-information DB 40, the data acquisition unit 32 reads and acquires only the bio-data matching the assessment condition determined in step S3. If the bio-data is assessed on a real-time basis, the data acquisition unit 32 may successively acquire all the bio-data output from the bio-sensor 14.

In step S5, the degree computing unit 33 performs a pre-process on the bio-data acquired in step S4. Specifically, the degree computing unit 33 computes the activity of the sympathetic nervous system by performing power-spectrum analysis on a time series of the cardiac beat-to-beat interval.

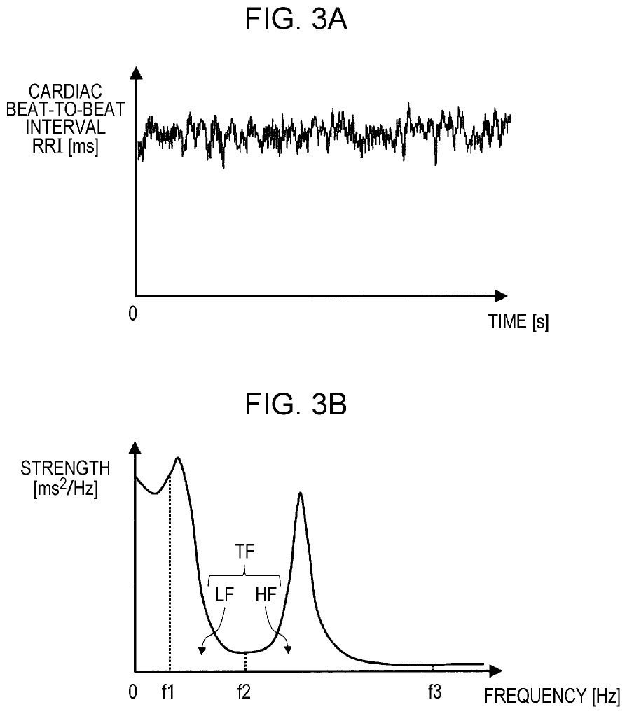

FIG. 3A illustrates the time characteristics of the cardiac beat-to-beat interval. The horizontal axis of the graph of FIG. 3A represents time (seconds), and the vertical axis of the graph represents the cardiac beat-to-beat interval (RRI; milliseconds). The RRI represents the interval of the R wave of the heart beat waveform. The power spectrum in FIG. 3B is obtained by fast Fourier transforming a predetermined number of plots (for example, 1024 plots) of time-series data.

FIG. 3B illustrates the power spectrum of the heart beat-to-beat interval in FIG. 3A. The horizontal axis of the graph of FIG. 3B represents frequency (Hz) and the vertical axis of the graph represents strength (ms²/Hz). The activity of the autonomic nervous system (for example, LF, HF, or TF) is computed using the power spectrum. Low frequency (LF) is an index indicating the cumulative strength in a low-frequency region and is an index indicating the activity of the sympathetic nerve. High frequency (HF) is an index indicating a cumulative strength in a high-frequency region and is an index indicating the activity of the parasympathetic nerve. Total frequency (TF) is an index indicating the cumulative strength (the sum of LF and HF) in almost the entire frequency range and is an index indicating the activity of the whole autonomic nervous system.

LF corresponds to the integral value of the power spectrum over a predefined low-frequency band [f1, f2]. HF corresponds to the integral value of the power spectrum over a predefined high-frequency band [f2, f3]. TF corresponds to the integral value of the power spectrum over a whole-frequency band [f1, f3]. In frequencies f1, f2, and f3, the relationship of f1<f2<f3 holds true. Typical numerical values are f1=0.05 Hz, f2=0.15 Hz, and f3=0.40 Hz.

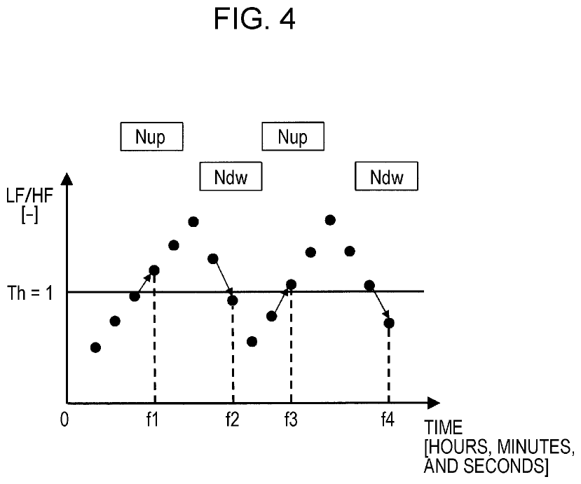

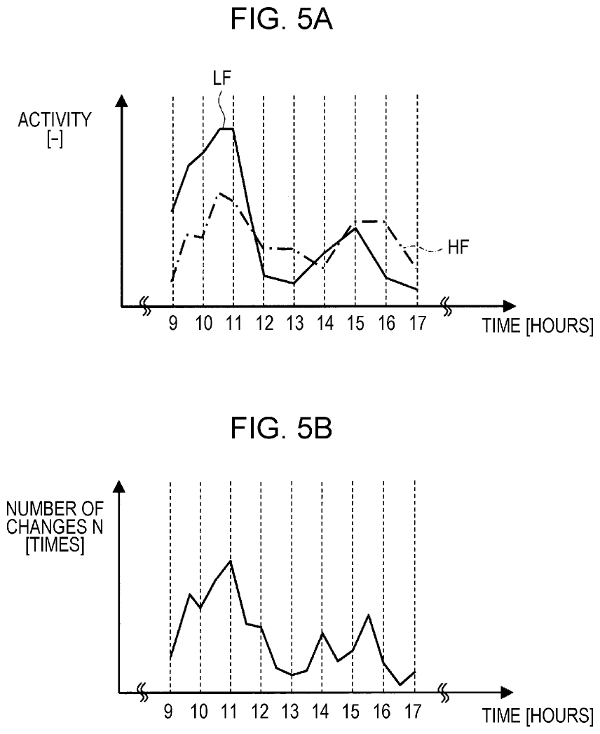

In step S6 of FIG. 2, the degree computing unit 33 computes the degree of change in a balance between the activity of the sympathetic nerve system and the activity of the parasympathetic nerve by using the time series of the activity obtained in the pre-process in step S5. The degree computing unit 33 computes as the degree of change the number of times by which a relative value between the activity of the sympathetic nerve and the activity of the parasympathetic nerve changes across a threshold value Th. The relative value may be a ratio of one activity to the other activity or a difference between the activities. The number of times by which LF/HF changes across the threshold value Th (hereinafter referred to as the number of changes N) is described in detail in accordance with FIG. 4 and FIGS. 5A and 5B.

The horizontal axis of the graph of FIG. 4 represents time (hours, minutes, and seconds), and the vertical axis of the graph represents LF/HF (no units). The relationship of LF/HF>1 (LF>HF) means that the user Us is in a biological state in which the parasympathetic nervous system is predominant. The relationship of LF/HF=1 (LF=HF) means that the user Us is in a biological state in which the sympathetic nerve and the parasympathetic nerve are functioning to almost the same extent. The level of the graph rises and falls repeatedly across the threshold value Th of 1 in a generally triangular plot.

The degree computing unit 33 counts the number of times by which the time series of LF/HF crosses the threshold value Th (=1) indicating an equilibrium state in a predetermined counting time period (for example, 30 minutes). For example, Nup is defined as a count when LF/HF is above the threshold value Th. The count Nup is incremented by 1 at times t1 and t3. Similarly, Ndw is defined as a count when LF/HF is below the threshold value Th. The count Ndw is incremented by 1 at times t2 and t4. The number of changes N is determined in accordance with N=Nup+Ndw by using Nup and Ndw counted in the counting time period. Since the difference between Nup and Ndw is as small as 0 or 1, N=Nup or N=Ndw may hold.

FIG. 5A illustrates an example of a time change in activity. In the graph of FIG. 5A, the horizontal axis represents time (seconds) and the vertical axis represents activity (no units). The mean value of the activity (LF or HF) is determined every 30 minutes, and characteristics of the time change are plotted as a line graph. The solid line graph corresponds to LF, and the dot-dash line graph corresponds to HF. In the graph, the activity of the sympathetic nerve is typically predominant for most of the morning (from 09:00 to 12:00) and the activity of the parasympathetic nerve is typically predominant for most of the afternoon (from 12:00 to 17:00).

FIG. 5B illustrates the time change in the number of changes N. In the graph of FIG. 5B, the horizontal axis represents time (seconds), and the vertical axis represents the number of changes N (times). The counting time interval is set to 30 minutes, the number of changes N is computed, and the characteristics of the time change are represented by a line graph. FIGS. 5A and 5B indicate a tendency that the number of changes N is larger in a time band where both LF and HF are higher (in particular, at or near 11:00).

In step S7 of FIG. 2, the creativity assessment unit 34 assesses the creativity of the user Us by using the number of changes computed in step S6. Specifically, the creativity assessment unit 34 assesses the creativity demonstration state of the user Us by referring to the time sequence of creativity. The number of changes N per unit time is converted into an index indicating the creativity demonstration state (hereinafter referred to as a degree of demonstration) in accordance with a conversion curve C1 corresponding to the user Us. The determination method of the conversion curve C1 is described.

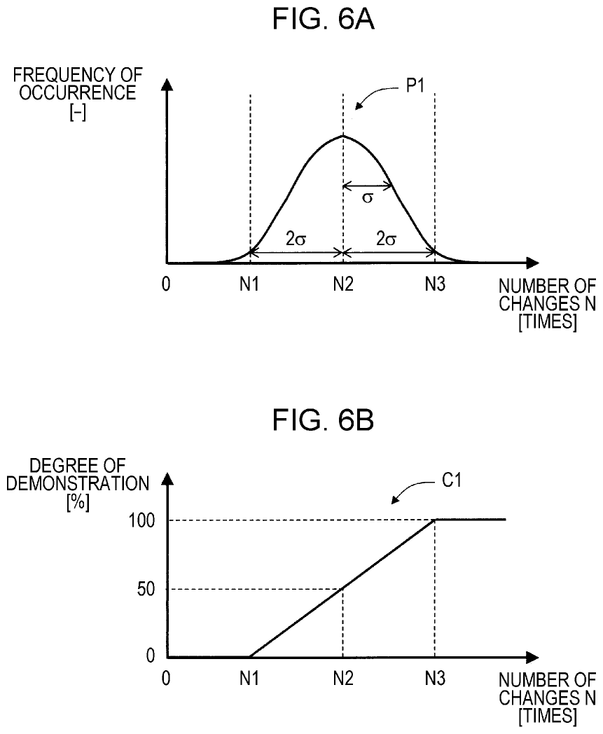

FIG. 6A illustrates a statistical distribution P1 of the number of changes with the same user constituting the population. In the graph of FIG. 6A, the horizontal axis represents the number of changes N (times) and the vertical axis represents frequency of occurrence (no units). The distribution P1 indicates samples of the number of changes N computed at every scene in the daily life of the same user Us. On the assumption that the distribution P1 agrees with the Gaussian distribution, an upper limit value N1 is the number of changes N corresponding to about the bottom 5 percent of the population (mean value −2σ). A mean value N2 is the number of changes N corresponding to the mean value of the population. A lower limit value N3 is the number of changes N corresponding to about the top 5 percent of the population (mean value +2σ). Note that a is the standard deviation of the population.

FIG. 6B illustrates an example of a conversion curve C1 used to convert the number of changes N into the degree of demonstration. In the graph of FIG. 6B, the horizontal axis represents the number of changes N (times) and the vertical axis represents the degree of demonstration (%). For example, the degree of demonstration ranges from 0 to 100%. A degree of demonstration closer to 100% indicates a state where creativity is more likely to be demonstrated and a degree of demonstration closer to 0% indicates a state where creativity is less likely to be demonstrated. The degree of demonstration is determined in accordance with the conversion curve C1 that reflects an individual difference of the user Us.

The shape of the conversion curve C1 corresponds to a linear function connecting three feature points (N1, 0), (N2, 50), and (N3, 100). A larger number of changes N is determined to have a higher degree of demonstration, and a smaller number of changes N is determined to have a lower degree of demonstration.

In step S8, the output information generating unit 35 generates information to be output (hereinafter referred to as output information), in accordance with assessment results obtained in step S7. The output information includes (1) interim information obtained in the middle of the assessment process or final information indicating assessment results (hereinafter referred to as assessment information) and (2) information indicating advice to improve or maintain the biological state (hereinafter referred to as advice information).

The output information generating unit 35 may acquire the contents of the advice from the advice information DB 42 and may generate advice information appropriate for the user Us. The advice information. DB 42 stores a different piece of the advice information, depending on at least one of the degree of change in the balance, the tendency of the balance to change, and the time ratio of the balance. The “tendency of the balance to change” denotes whether the tendency of the time change of LF/HF is an increasing tendency, a decreasing tendency, or a maintained tendency. The “time ratio of the balance” denotes a time ratio of the time when the sympathetic nerve is predominant to the time when the parasympathetic nerve is predominant.

If a state of a higher degree of demonstration is maintained, the user Us may be advised to maintain that state. If the time change in the degree of demonstration is larger, the user Us may be advised to remember their own behavior during the time band of the higher degree of demonstration and to behave in the same manner again.

If LF/HF tends to increase, rising or falling away from the threshold value Th in time (Condition 1), or if the time ratio of the predominant sympathetic nerve is higher with a lower degree of demonstration (Condition 2), the user Us is advised to take action to suppress the sympathetic nerve or activate the parasympathetic nerve. Specifically, the user Us may be advised to smell a scent that induces relaxation, to regulate the respiratory rate to about one breath per 6 seconds, and/or to listen to music tuned to a frequency of 528 Hz.

Conversely, if LF/HF tends to decrease, rising or falling closer to the threshold value Th in time (Condition 3), or if the time ratio of the predominant parasympathetic nerve is higher with a lower degree of demonstration (Condition 4), the user Us is advised to take action to activate the sympathetic nerve or suppress the parasympathetic nerve. Specifically, the user Us may be advised to have a caffeinated drink or food, to regulate the respiratory rate to about 10 seconds, and/or to listen to uplifting music.

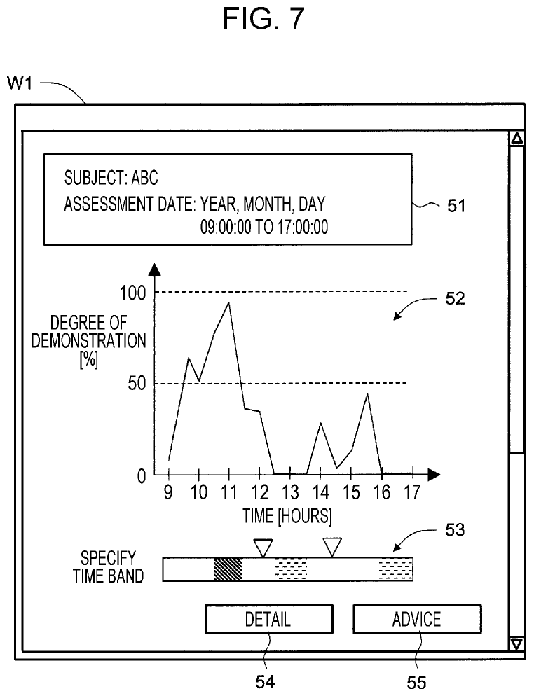

In step S9, the output unit 20 outputs the output information generated in step S8 in association with the measurement time of the biological state. In this way, the assessment information and the advice information are output as information recognizable by the user Us (such as a window W1 in FIG. 7).

FIG. 7 illustrates a first image of a display example of the assessment information. The window W1 includes from top to bottom a character region 51, a graph region 52, a slider bar 53, and two buttons, namely a detail button 54 and an advice button 55. Information related to the assessment condition (the name of the subject and time and date of the assessment) is displayed in the character region 51. A graph indicating the time change in the degree of demonstration is displayed in the graph region 52. The slider bar 53 is a control by which the user Us specifies any time band falling within the range of time as an assessment target (hereinafter referred to as a specific time band). The slider bar 53 is displayed such that a time band assessed to have a higher degree of demonstration (near 11:00) and a time band assessed to have a lower degree of demonstration (near 13:00 and 16:00 or later) are displayed in different colors.

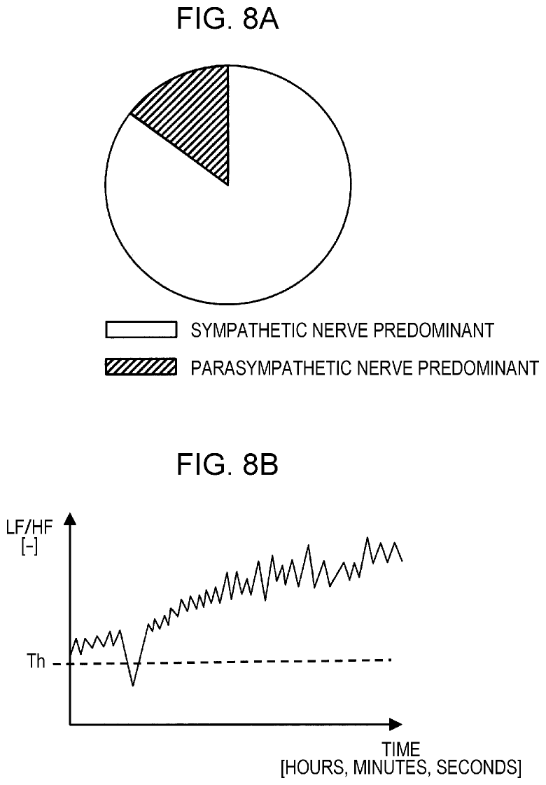

The detail button 54 is a user control which causes detailed analysis information in the specific time band to be displayed. For example, the output unit 20 may display graphs in FIGS. 8A and 8B in a screen area different from the screen area for the window W1 in response to an operation performed by the user Us on the detail button 54. FIG. 8A is a circular graph that indicates a time ratio of the predominant sympathetic nerve to the predominant parasympathetic nerve in the specific time period. FIG. 8B illustrates a detailed time change of LF/HF close to the time when the number of changes N is counted.

The advice button 55 is a user control which causes the advice information to be displayed during the specific time band. For example, the output unit 20 may provide information by outputting text or voice in response to the operation on the advice button 55 by the user Us. Examples of the advice are described below.

“You were in a state in which the autonomic nervous system was well balanced and creativity was more easily demonstrated in the morning of May 14. Remember where you were in this time period, what you were doing, and what situation you were in. When you are doing a creative job from now on, keep in mind to take action similar to the one taken then.”

“You were in a state in which the parasympathetic nerve was relatively more active and creativity was more difficult to demonstrate in the afternoon of May 14. Creativity may be more easily demonstrated by activating the sympathetic nerve in this time band. For example, (1) have a caffeinated drink, (2) regulate the respiratory rhythm to once every 10 seconds, and/or (3) listen to uplifting music.”

The user Us may reflect on their behavior in the middle of a task in accordance with information provided by the creativity assessment apparatus 10. In this way, the user Us may analyze or learn (1) the time band in which the degree of demonstration tends to increase or decrease, (2) the duration for which a higher degree of demonstration is able to be maintained, and (3) the action that triggers a higher or lower degree of demonstration of creativity.

In step S10, the user terminal 12 stores the assessment results obtained in step S7. Specifically, the assessment information generated by the user terminal 12 (the time change in the degree of demonstration in FIG. 7) is stored on the memory 24, and the assessment information DB 44 is thus stored and updated. For example, the user Us confirms the assessment results before performing a subsequent task similar to the previous one, thereby setting themselves in a state in which creativity is more easily demonstrated.

As described above, the creativity assessment apparatus 10 includes the data acquisition unit 32 (acquisition unit), the degree computing unit 33 (computing unit), and the creativity assessment unit 34 (assessment unit). The data acquisition unit 32 acquires the bio-data indicating the measurement results of the biological state of the user Us. The degree computing unit 33 computes the number of changes N (degree of change) in the balance between the activity of the sympathetic nerve and the activity of the parasympathetic nerve in accordance with the acquired bio-data. The creativity assessment unit 34 assesses the creativity of the user Us in accordance with the computed number of changes N. The creativity assessment method and program of the first exemplary embodiment causes one or more computers to perform an acquisition step (S4) that acquires the bio-data, a computation step (S6) that computes the number of changes N in accordance with the acquired bio-data, and an assessment step (S7) that assesses the creativity of the user Us in accordance with the computed number of changes N. In this configuration, the creativity of the user Us may be assessed using the bio-data and may be more easily recognized than when a creativity test is performed on a single task multiple times.

The degree computing unit 33 may compute as the degree of change the number of changes N by which the relative value (LF/HF) between the activity of the sympathetic nerve (LF) and the activity of the parasympathetic nerve (HF) changes across the threshold value Th. In this case, the creativity assessment unit 34 may assess a larger number of changes N to be a higher degree of creativity and may assess a smaller number of changes N to be a lower degree of creativity. The creativity of the user Us may be assessed at a higher accuracy level by using a positive correlation present between the number of changes N and the degree of creativity.

The creativity assessment apparatus 10 may include an output unit 20 that outputs in association with the measurement time of the biological state the assessment results provided by the creativity assessment unit 34 or information that is generated in accordance with the assessment results. A person (such as the user Us) having received the information may be informed of the assessment results that are associated with the measurement time.

The creativity assessment unit 34 may assess the time sequence of the demonstration state of creativity of the same user Us, and the output unit 20 may output the slider bar 53 (time band information) indicating the time band in which the user Us is in the state in which creativity is more easily or less easily demonstrated. In this way, the person having received the information may reflect on the state in which creativity is more easily or less easily demonstrated.

The output unit 20 may output the advice information that indicates a piece of advice to improve the biological state in the time band that is assessed to be in the state in which creativity is less easily demonstrated. In this way, in accordance with the contents of the advice, the person having received the advice information may easily take action in a similar future condition to improve their biological state.

The output unit 20 may output advice information that differs depending on at least one of the degree of change, the tendency of the balance to change, and the time ratio of the balance. In this way, meticulous advice is provided in view of a difference between the degree of change, the tendency of the balance to change, and the time ratio of the balance.

### Modifications of First Exemplary Embodiment

In step S3 of FIG. 2, the assessment condition determination unit 31 determines the time range in response to the input operation performed by the user Us. The disclosure is not limited to this determination method. For example, the assessment condition determination unit 31 may determine as the time range only a time band in which the user Us performs a task in a sedentary state (for example, paper work). If the task involves moving, the autonomic nervous system becomes unstable in activity, possibly leading to lower reliability of the assessment results.

Specifically, the assessment condition determination unit 31 may estimate the time band for the paper work by using the information indicating a state of the user Us (hereinafter referred to as state information) or information indicating a plan of action of the user Us (planning information). An example of the state information may include sensing information that is obtained using a motion sensor that senses an amount of motion of the user Us, an object sensor that senses the presence or absence of the user Us, or an object sensor that senses the state of a device used to perform the task. An example of the planning information may include information indicating a schedule available through schedule management software (scheduler information).

By automatically determining the time range, the data acquisition unit 32 acquires only the bio-data measured in the time band during which the user Us performs a predetermined task. Together with or independently of this operation, the degree computing unit 33 may compute the degree of change by using only the bio-data that is measured for the time band during which the user Us performs the predetermined task. In this way, the handling amount of the bio-data may be smaller than when the time band is not limited.

In steps S5 through S7 in FIG. 2, the controller 22 computes the index (degree of demonstration) indicating the demonstration state of creativity in accordance with the computing method of FIGS. 3A through 6B. The disclosure is not limited to the computing method described above. For example, the activity, the number of changes N, the definition of the degree of demonstration and the shape of the function of the conversion curve C1 may be modified in a variety of ways.

For example, the activity of the autonomic nervous system may be very low frequency (VLF) indicating the cumulative strength in a very low frequency region or may be a component coefficient of variance (CCV). The threshold value Th used to compute the number of changes N is not limited to 1 and may be a value closer to 1. The input variable of the conversion curve C1 is not limited to one type of variable (the number of changes N) and may be a combination of other types of variable (a variety of variables including attributes of time, place, and environment).

Another degree of change may be used instead of the number of changes N. Specifically, the relative value of activity (such as LF/HF) may be a ratio of a total time in which the relative value (for example, LF/HF) of activity falls within a vicinity region of the threshold value Th (for example, 0.5≤LF/HF≤2) to a total time in which the relative value (for example, LF/HF) of activity falls outside the vicinity region. This is because an increase in the time to move around in the vicinity region of the threshold value Th indicating an equilibrium state increases the frequency of occurrence of balance changes in the autonomic nervous system.

### Second Exemplary Embodiment

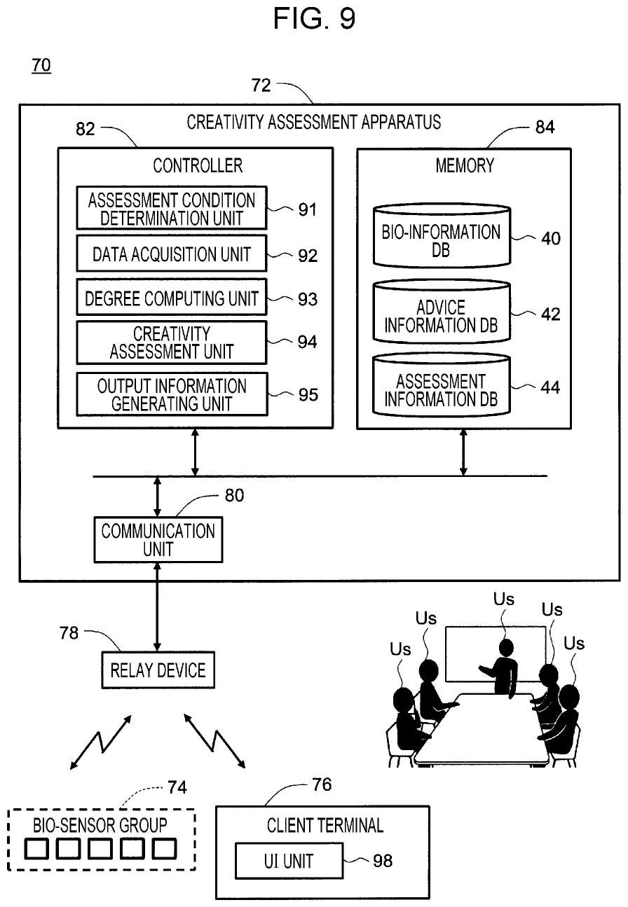

A creativity assessment apparatus of a second exemplary embodiment of the disclosure is described in connection with FIGS. 9 through 11. Configurations and functions identical to those of the first exemplary embodiment are designated with the same reference numerals and the discussion thereof is omitted.

FIG. 9 generally illustrates a creativity assessment system 70 including a creativity assessment apparatus 72 of a second embodiment of the disclosure. The creativity assessment system 70 assesses creativity of multiple users Us (difference between relative abilities) serving as subjects. Five users Us may now be present in a particular meeting, for example.

The creativity assessment system 70 includes a creativity assessment apparatus 72, a bio-sensor group 74, a client terminal 76, and a relay device 78. The creativity assessment apparatus 72 is a server playing a leading role of the creativity assessment system 70. The creativity assessment apparatus 72 includes a communication unit 80 (output unit), a controller 82, and a memory 84.

The communication unit 80 is an interface that receives or transmits an electrical signal from or to an external device. The creativity assessment apparatus 72 may thus receive the bio-data from the bio-sensor group 74 and transmit output information generated thereby to the client terminal 76.

The controller 82 includes a processor, such as a central processing unit (CPU) or a micro-processing unit (MPU). By reading and then executing a program stored on the memory 84, the controller 82 implements the functions of an assessment condition determination unit 91, a data acquisition unit 92 (acquisition unit), a degree computing unit 93 (computing unit), a creativity assessment unit 94 (assessment unit), and an output information generating unit 95.

The memory 84 is non-transitory and includes a computer readable storage medium. The memory 84 stores data and a program in accordance with which the controller 82 controls each element of the creativity assessment system 70. As with the first exemplary embodiment, the memory 84 includes the bio-information DB 40, the advice information DB 42, and the assessment information DB 44.

The bio-sensor group 74 is a set of bio-sensors worn by multiple users Us. In the same way as with the first exemplary embodiment, each sensor is configured to measure the biological state of the user Us, such as the heart rate variability, pulse wave, and respiratory rate of each user Us. The client terminal 76 may be a personal computer, a tablet, or a smart phone, for example. The client terminal 76 is configured to output the assessment results provided by the creativity assessment apparatus 72. The client terminal 76 includes a user interface (hereinafter referred to as a UI unit 98) which includes a combination of an input device and output device (not illustrated).

The creativity assessment apparatus 72, the bio-sensor group 74, and the client terminal 76 are interconnected to each other via the relay device 78. The creativity assessment system 70 is not only configured as an apparatus or a system, but also configured in a variety of other ways.

The creativity assessment apparatus 72 of the second exemplary embodiment is configured as described above. The operation of the creativity assessment system 70 including the creativity assessment apparatus 72 is described in connection with the flowchart of FIG. 2. Before the operation, the users Us serving as subjects start tasks in which creativity is to be demonstrated (for example, a meeting for brain-storming) after each user Us has worn the bio-sensor on a particular location of the user's body.

In step S1 of FIG. 2, the creativity assessment apparatus 72 collects the bio-data successively output from the bio-sensor group 74. Before collecting the bio-data, the bio-sensor group 74 successively measures the biological states of the users Us and outputs periodically or non-periodically the obtained bio-data via communication. The communication unit 80 successively receives the bio-data from the bio-sensor group 74. The controller 82 stores on the memory 84 the received bio-data in association with other related information. The bio-information DB 40 is thus stored and updated.

In step S2, the creativity assessment apparatus 72 receives a start instruction to start the assessment process to assess creativity. Specifically, an analyzer performs an input operation for the assessment condition and a start operation for the assessment process using the UI unit 98 in the client terminal 76. In response, the client terminal 76 generates the start instruction in response to the operation performed by the analyzer and transmits the start instruction to the creativity assessment apparatus 72. The controller 82 thus receives the start instruction from the analyzer.

In step S3, the assessment condition determination unit 91 determines the assessment condition by acquiring the information input in step S2. In step S4, the data acquisition unit 92 acquires the bio-data for the assessment process for each user Us. In this way, the five users Us participating in the same event are set to be assessment targets and the bio-data indicating the biological state of each user Us is thus acquired.

In step S5, the degree computing unit 93 performs a pre-process on the bio-data acquired in step S4. In step S6, the degree computing unit 93 computes the degree of change on each user Us using the time sequence of the activity obtained in the pre-process in step S5. In this way, the degrees of change of the five users Us (for example, a maximum value of the number of changes N within the time range of the assessment target).

In step S7, the creativity assessment unit 94 assesses the creativity of the user Us using the number of changes N computed in step S6. Specifically, the creativity assessment unit 94 relatively assesses the abilities of creativity of the users Us. In this case, the number of changes N of each user Us is converted into an index indicating the ability of creativity (hereinafter referred to as a score) in accordance with a statistically determined conversion curve C2. The method of determining the conversion curve C2 is described below.

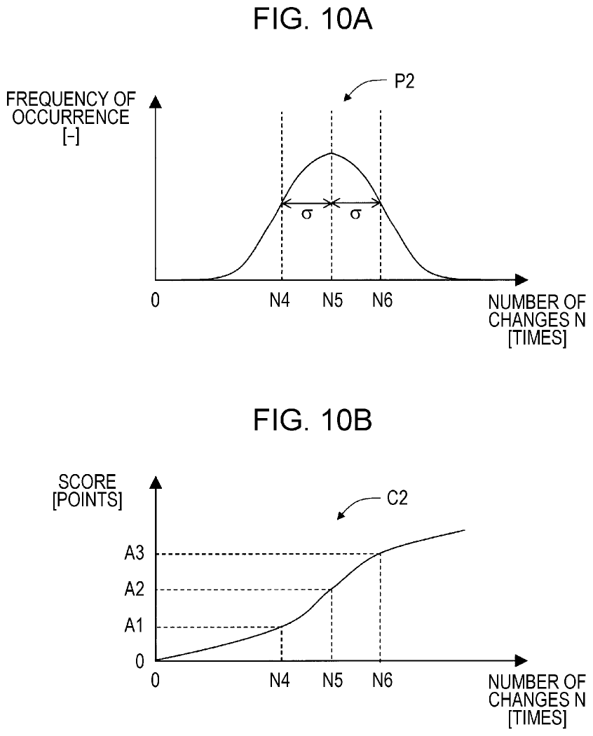

FIG. 10A illustrates a statistical distribution P2 of the number of changes N in accordance with the users Us served as a population. In the graph of FIG. 10A, the horizontal axis represents the number of changes N while the vertical axis represents frequency of occurrence (with no unit). The distribution P2 is obtained by sampling the number of changes N in the state that creativity is demonstrated at a maximum level (namely, a maximum individual value). In accordance with on the assumption that the distribution P2 agrees with the Gaussian distribution, an upper limit value N4 is the number of changes N corresponding to the bottom 16 percent of the population (mean value −σ). A mean value N5 is the number of changes N corresponding to the mean value of the population. A lower limit value N6 is the number of changes N corresponding to the top 16 percent of the population (mean value +σ). Note that σ represents the standard deviation of the population.

FIG. 10B illustrates an example of the conversion curve C2 that converts the number of changes N into a score. In the graph of FIG. 10B, the horizontal axis represents the number of changes N (times) while the vertical axis represents scores (points). The score is defined as 0 or a positive value. A higher score represents a higher ability of creativity and a lower score represents a lower ability of creativity. The score is determined in accordance with the conversion curve C2 that is common to the users Us.

The conversion curve C2 has a gradually increasing shape of function that is a curve connecting three feature points (N4, A1), (N5, A2), and (N6, A3). The feature points A1, A2, and A3 satisfy the relationship of A1<A2<A3 and correspond to adjustment values that normalize the distribution of scores. Specifically, a larger number of changes N is assessed as having a higher ability of creativity and a smaller number of changes N is assessed as having a lower ability of creativity.

In step S8, the output information generating unit 95 generates the information to be output to outside (namely, the output information) in response to the assessment results obtained in step S7. In step S9, the communication unit 80 outputs to outside (the client terminal 76) the output information generated in step S8 in association with the measurement time of the biological state.

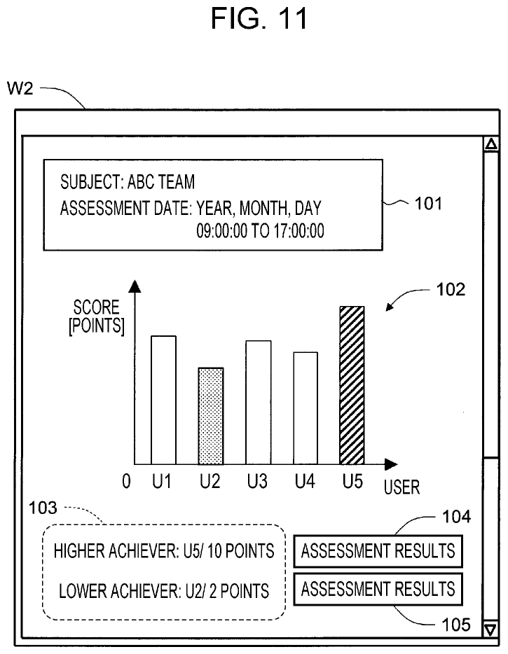

The client terminal 76 receives the output information from the creativity assessment apparatus 72 via the relay device 78 and outputs at least visualization information via the UI unit 98. In this way, the assessment information and the advice information are output as the information recognizable by the analyzer (for example, a window W2 of FIG. 11).

FIG. 11 illustrates a second image of a display example of the output information. The window W2 includes from top to bottom a character region 101, a graph region 102, a character region 103, and two buttons 104 and 105 for assessment results. Information related to the assessment condition (the group name of the subjects and time and date of the assessment) is displayed in the character region 101. A bar graph indicating the score of each user Us is displayed in the graph region 102. The name and score of a higher achiever and the name and score of a lower achiever are displayed in the character region 103. A higher achiever (U5) assessed having the highest score and a lower achiever (U2) assessed having the lowest score are displayed in different colors in the bar graph in the graph region 102.

The assessment result button 104 is a user control to display the assessment results of the higher achiever (U5). The assessment result button 105 is a user control to display the assessment results of the lower achiever (U2). In response to an operation performed on the button 104 or 105 by the analyzer, the UI unit 98 in the client terminal 76 may display another window W1 (FIG. 7) in addition to the window W2 at the same time. As described with reference to the first exemplary embodiment, the analyzer may view the assessment results of a particular user Us.

The analyzer reflects back on the behavior of each user Us in the middle of the task, in accordance with the information provided by the creativity assessment system 70. For example, the analyzer may learn (1) a user having a higher score or a lower score, (2) why the user is assessed as a higher achiever or a lower achiever, (3) how is the compatibility of the members, and (4) whether a preparation and an environment to increase creativity have been successfully provided.

In step S10, the creativity assessment apparatus 72 stores the assessment results obtained in step S7. Specifically, the creativity assessment apparatus 72 stores on the memory 84 the assessment information generated by the creativity assessment apparatus 72 (the score of each user Us of FIG. 11), thereby storing and updating the assessment information DB 44. The analyzer may thus run tasks in a manner such that creativity is increased, by confirming the assessment results before performing a task coming in next and similar to the current one.

As described above, the creativity assessment apparatus 72 includes the data acquisition unit 92 (acquisition unit) that acquires the bio-data, the degree computing unit 93 (computing unit) that computes the number of changes N, in accordance with the acquired bio-data, and the creativity assessment unit 94 (assessment unit) that assesses the creativity of the user Us, in accordance with the computed number of changes N. In this configuration, the second embodiment provides the same effect as that of the first exemplary embodiment. Specifically, the creativity of the user Us may be easily learned better than when the creativity test is performed by multiple times in connection with a single task.

The data acquisition unit 92 may acquire the bio-data on each user Us, the degree computing unit 93 computes the number of changes N on each user Us, the creativity assessment unit 94 relatively assesses the ability of creativity of each of the users Us, and the communication unit 80 or the UI unit 98 (output unit) may output relative assessment results or the information generated in accordance with the assessment results. In this way, a person (for example, the analyzer) having received the information may learn the relative assessment results of the users Us.

The communication unit 80 or the UI unit 98 may output the assessment results concerning a higher achiever assessed as having a relatively higher ability of creativity and/or the assessment results concerning a lower achiever assessed as having a relatively lower ability of creativity. With reference to the assessment results in this way, the person having received the information may reflect back on the behavior of the user Us having a relatively higher (or lower) ability of creativity.

### Modifications of Second Exemplary Embodiment

In step S7 of FIG. 2, the controller 82 (the creativity assessment unit 94) computes the index (score) indicating the ability of creativity in accordance with the computing method of FIG. 11. The disclosure is not limited to the computing method described above. For example, the activity, the number of changes N, the degree of demonstration, the definition of the score, and the shape of the function of the conversion curve C2 may be modified in a variety of ways. In particular, the input variable of the conversion curve C2 is not limited to one type (the number of changes N), but may be a combination of other types of variables (a variety of variables including attributes of time, place, and environment).

One user Us as a higher achiever and the other user Us as a lower achiever are selectively displayed in the character region 103 of the window W2 of FIG. 11. The disclosure is not limited to this selection method. Three persons or more (for example, five higher achievers and three lower achievers) may be selected. Persons may be selected according to a ratio of persons (for example, the parsons falling with the top 10 percent and the bottom 5 percent).

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A creativity assessment apparatus comprising:
an acquisition unit that acquires bio-data indicating a measurement result of a biological state of a user;
a computing unit that computes a degree of change in a balance between sympathetic nerve activity and parasympathetic nerve activity in accordance with the bio-data acquired by the acquisition unit; and
an assessment unit that assesses creativity of the user in accordance with the degree of change computed by the computing unit.

2. The creativity assessment apparatus according to claim 1, wherein the computing unit computes as the degree of change a number of times by which a relative value between the sympathetic nerve activity and the parasympathetic nerve activity changes across a predetermined threshold value.

3. The creativity assessment apparatus according to claim 2, wherein the assessment unit determines a larger number of times to be an indicator of higher creativity and determines a smaller number of times to be an indicator of lower creativity.

4. The creativity assessment apparatus according to claim 1, further comprising an output unit that outputs a result of the assessment by the assessment unit or information generated based on the result of the assessment, in association with a measurement time of the biological state.

5. The creativity assessment apparatus according to claim 2, further comprising an output unit that outputs a result of the assessment by the assessment unit or information generated based on the result of the assessment, in association with a measurement time of the biological state.

6. The creativity assessment apparatus according to claim 3, further comprising an output unit that outputs a result of the assessment by the assessment unit or information generated based on the result of the assessment, in association with a measurement time of the biological state.

7. The creativity assessment apparatus according to claim 4, wherein the assessment unit monitors a creativity demonstration state of a user for a period of time, and
wherein the output unit further outputs time band information indicating at least one of a high creativity time band or a low creativity time band of the user based on the monitoring, the high creativity time band being a time band during which the user is more likely to demonstrate creativity, the low creativity time band being a time band during which the user is less likely to demonstrate creativity.

8. The creativity assessment apparatus according to claim 5, wherein the assessment unit monitors a creativity demonstration state of a user for a period of time, and
wherein the output unit further outputs time band information indicating at least one of a high creativity time band or a low creativity time band of the user based on the monitoring, the high creativity time band being a time band during which the user is more likely to demonstrate creativity, the low creativity time band being a time band during which the user is less likely to demonstrate creativity.

9. The creativity assessment apparatus according to claim 6, wherein the assessment unit monitors a creativity demonstration state of a user for a period of time, and
wherein the output unit further outputs time band information indicating at least one of a high creativity time band or a low creativity time band of the user based on the monitoring, the high creativity time band being a time band during which the user is more likely to demonstrate creativity, the low creativity time band being a time band during which the user is less likely to demonstrate creativity.

10. The creativity assessment apparatus according to claim 7, wherein the output unit further outputs advice information that advises the user to improve the biological state in the time band during which the user is in the state in which creativity tends to be demonstrated less.

11. The creativity assessment apparatus according to claim 8, wherein the output unit further outputs advice information that advises the user to improve the biological state in the time band during which the user is in the state in which creativity tends to be demonstrated less.

12. The creativity assessment apparatus according to claim 9, wherein the output unit further outputs advice information that advises the user to improve the biological state in the time band during which the user is in the state in which creativity tends to be demonstrated less.

13. The creativity assessment apparatus according to claim 10, wherein the output unit outputs the advice information that is different in response to at least one of the degree of change, a tendency in which the balance changes, and a time ratio of the balance.

14. The creativity assessment apparatus according to claim 11, wherein the output unit outputs the advice information that is different in response to at least one of the degree of change, a tendency in which the balance changes, and a time ratio of the balance.

15. The creativity assessment apparatus according to claim 12, wherein the output unit outputs the advice information that is different in response to at least one of the degree of change, a tendency in which the balance changes, and a time ratio of the balance.

16. The creativity assessment apparatus according to claim 4, wherein the acquisition unit acquires the bio-data on a per-user basis,
wherein the computing unit computes the degree of change on a per-user basis,
wherein the assessment unit relatively assesses abilities of creativity of a plurality of users, and
wherein the output unit outputs relative assessment results provided by the assessment unit or information that is generated in accordance with the relative assessment results.

17. The creativity assessment apparatus according to claim 5, wherein the acquisition unit acquires the bio-data on a per-user basis,
wherein the computing unit computes the degree of change on a per-user basis,
wherein the assessment unit relatively assesses abilities of creativity of a plurality of users, and
wherein the output unit outputs relative assessment results provided by the assessment unit or information that is generated in accordance with the relative assessment results.

18. The creativity assessment apparatus according to claim 16, wherein the output unit outputs assessment results for a user as a higher achiever whose ability of creativity is assessed as relatively higher and/or assessment results for a user as a lower achiever whose ability of creativity is assessed as relatively lower.

19. The creativity assessment apparatus according to claim 1, wherein the acquisition unit acquires only the bio-data that is measured in a time band during which a predetermined task is performed and/or the computing unit computes the degree of change by using only the bio-data that is measured in the time band during which the predetermined task is performed.

20. A non-transitory computer readable medium storing a program causing a computer to execute a process for assessing creativity, the process comprising:
acquiring bio-data indicating a measurement of a biological state of a user;
computing a degree of change in a balance between sympathetic nerve activity and parasympathetic nerve activity in accordance with the acquired bio-data; and
assessing the creativity of the user in accordance with the computed degree of change.
